(19) United States
(12) Patent Application Publication
(10) Pub. No.: US 2014/0040785 A1
(43) Pub. Date: Feb. 6, 2014

(54) BROWSER-BASED PROCESS FLOW CONTROL RESPONSIVE TO AN EXTERNAL APPLICATION

(71) Applicants: Terence Munday, Menlo Park, CA (US); Trevor Mathers, Portland, OR (US); Tom Poulsen, Los Gatos, CA (US); Andrew Rundell, Ashland, OR (US); John Cafolla, Mountain View, CA (US)

(72) Inventors: Terence Munday, Menlo Park, CA (US); Trevor Mathers, Portland, OR (US); Tom Poulsen, Los Gatos, CA (US); Andrew Rundell, Ashland, OR (US); John Cafolla, Mountain View, CA (US)

(73) Assignee: Oracle International Corporation, Redwood Shores, CA (US)

(21) Appl. No.: 13/564,432

(22) Filed: Aug. 1, 2012

(51) Int. Cl. G06F 3/01

(52) U.S. Cl. 715/760

(57) ABSTRACT

A method, system, and computer program product for browser rendering and control extensions for browser rendering that is responsive to external applications that are at least partially controlled by user gestures from the browser. The method commences by authenticating a user, then rendering an initial display comprising a plurality of graphical components corresponding to respective prescribed user activities. The browser receives a user interface gesture corresponding to a user selected one of the prescribed user activities, and proceeds to access a flow metadata repository to retrieve external application launch parameters which are then used to launch one or more external applications. The browser receives task state indications from the external application and re-renders the display based on the received task state indications. The user activities correspond to a READ type of user activity, a SEE type of user activity, or DO types of user activity, or in any combinations thereof.

### COPYRIGHT NOTICE

A portion of the disclosure of this patent document contains material which is subject to copyright protection. The copyright owner has no objection to the facsimile reproduction by anyone of the patent document or the patent disclosure, as it appears in the Patent and Trademark Office patent file or records, but otherwise reserves all copyright rights whatsoever.

### FIELD

The disclosure relates to the field of browser rendering and control extensions and more particularly to techniques for browser-based process flow control responsive to an external application.

### BACKGROUND

There are a number of ways to expose potential customers to functionality available in business software, for example, by engaging the potential customer through a series of on-site presentations and in-situ demos. With the advent of the internet, and internet “cloud” implementation, and with the ability to deliver software as a service (SaaS), the aforementioned methods of engaging the potential customer are quickly becoming outdated, at least inasmuch as the costs of engaging the potential customer through a series of on-site presentations and in-situ demos is becoming prohibitive.

The rapid advances in the capabilities of business software demand new techniques where customers can explore the functionality of such business software. Indeed, modern business software applications typically require expertise to set up, and additional expertise to deploy and manage. Often, the extent of expertise required makes it impractical and/or not competitive for a vendor of business software applications to establish a custom evaluation environment for each sales engagement.

What is needed is the capability to quickly and inexpensively deploy a “trial” or evaluation for a given sales engagement without reliance on on-site presentations and in-situ demos. More specifically, what is needed are techniques to provision an evaluation using internet and software in lieu of on-site resources. The disclosed embodiments seize the best aspects of on-site sales support by providing a virtual evaluation environment using a browser-based process flow control that is responsive to the offered business software application. Legacy approaches do not provide such capabilities, therefore, there is a need for an improved approach.

### SUMMARY

The present disclosure provides an improved method, system, and computer program product suited to address the aforementioned issues with legacy approaches. More specifically, the present disclosure provides a detailed description of techniques used in methods, systems, and computer program products for browser-based process flow control responsive to an external application.

Disclosed are methods, systems, and computer program product embodiments for browser rendering and control extensions. In exemplary operation, browser rendering is responsive to external applications that are at least partially controlled by user gestures initiated at the browser. One method commences by authenticating a user, then rendering an initial display comprising a plurality of graphical components corresponding to respective prescribed user activities. The browser receives a user interface gesture corresponding to a user selected one of the prescribed user activities, and proceeds to access a flow metadata repository to retrieve external application launch parameters which are then used to launch one or more external applications. The browser receives task state indications from the external application and re-renders the display based on the received task state indications. Example user activities correspond to a READ type of user activity, a SEE type of user activity, or DO types of user activity, or in any combinations thereof

Further details of aspects, objectives, and advantages of the disclosure are described below in the detailed description, drawings, and claims. Both the foregoing general description of the background and the following detailed description are exemplary and explanatory, and are not intended to be limiting as to the scope of the claims.

### BRIEF DESCRIPTION OF THE DRAWINGS

FIG. 1A is a block diagram of a system for implementing browser-based process flow control responsive to an external application, according to some embodiments.

FIG. 1B is a block diagram showing dynamic rendering in a system for implementing browser-based process flow control responsive to an external application, according to some embodiments.

FIG. 2 is a function-to-module map for implementing browser-based process flow control responsive to an external application, according to some embodiments.

FIG. 3 is a sequence diagram representation of a protocol used in systems for browser-based process flow control responsive to an external application, according to some embodiments.

FIG. 4 is a flow chart representation of a technique for updating a display in a system for browser-based process flow control responsive to an external application, according to some embodiments.

FIG. 5 is a schematic diagram of a system for browser-based process flow control responsive to an external application, according to some embodiments.

FIG. 6 depicts a block diagram of an instance of a computer system suitable for implementing an embodiment of the present disclosure.

### DETAILED DESCRIPTION

Some embodiments of the present disclosure are directed to an improved approach for implementing browser-based process flow control responsive to an external application. More particularly, disclosed herein are environments, methods, and systems for implementing browser-based process flow control responsive to an external application.

### Overview

One solution to the sales prospect engagement problems described above is to deploy a “trial” of the product, where the software product is provided to the sales prospect for a limited time. During this limited time, the sales prospect can evaluate a fully-featured product in order to gain a sufficient confidence level to make a purchase decision. Such an approach has been taken by software vendors, and that approach or variants thereto have generally proven to be vastly superior to the legacy techniques of on-site presentations. Yet, as software products become more and more sophisticated, prospects need more and more guidance in order to stay focused on features or aspects of the product that result in a confidence-inspiring evaluation.

One solution involves a method to establish a trial where control of a demo console or evaluation console can be accomplished from an instance of the software product being evaluated. A trial might be defined so as to suggest and/or enforce a specific traversal through the features and/or milestones of the software product being evaluated.

In some environments, the console (e.g., a demo console or evaluation console) communicates with an instance of the software product being evaluated using metadata. In such an embodiment, the metadata is accessible to both the console as well as to the instance of the software product being evaluated:
The console can read such metadata to establish an initial “trial” framework, and
The software product being evaluated can access the metadata to determine changes in the “flow state” as the user moves through the trial. The software product being evaluated can also access the metadata to update the flow state as the progression of the user of the software product being evaluated moves through various states.

Given such a capability (as is further described in the text and figures herein) a trial can be defined by a sales team or application development team, and a prescribed (e.g., prescribed via codification in the metadata) flow can be enforced. A flow can comprise a sequence of allowed or permitted state progressions that can be defined in a metadata representation. Then, the prospect can move through the trial, traversing through the permitted state progressions, and each state progression can be communicated to the software product being evaluated. In turn, the software product being evaluated can perform operations at the direction of the prospect, and can return an indication of state progression (e.g., successful completion of an operation). The console can receive an indication of state progression content from the software product being evaluated, and the console can render a depiction of the transition through the flow. Such a transition might be coordinated with other states and transitions, and other states and transitions might be coordinated with a milestone events or milestone markers that are displayed in a console window.

As can be understood from the foregoing, the flow of a trial can be defined as a set of events for progressing into and out of states (e.g., tasks) and progression to other certain states (e.g., completion of tasks) representing milestones in a process flow. Following the foregoing examples:
Milestones might correspond to some set of business activities being achieved or completed in the course of progression through the flow.
Tasks might correspond to steps the user needs to take to complete the business user activity.
There can be many milestones in a trial, and each milestone can have one or more tasks associated with it.
Administrators (e.g., trial designers, advanced users) can define dependencies to be enforced such that progression from one task to another is only permitted when the dependency constraints of the transition (or transitions) have been satisfied. Such definitions can be codified in metadata.

### Metadata

In certain embodiments, metadata is created (e.g., some portion manually generated and/or some portion machine-generated) to codify progression from one task to another, and to codify dependencies and/or other constraints. In some cases the metadata is stored in a persistent storage location (e.g., in a file, in a database engine), and in some cases metadata is stored in the payload of a given task in the trial. In addition to codifying the existence of tasks and any dependencies, the metadata can define how the user interface should be rendered. Further, the metadata can define what action to take when the user interacts with the various components of the interface (e.g., see the READ user activity, SEE user activity, and DO user activity as described below). In some embodiments, including some embodiments as described herein, there are three metadata tags supported as described in Table 1.

TABLE 1
User Activity Tags

| | Task | |
|---|---|---|
| Tag | Label | Examples (Description/Usage) |
| pReadIt | Read | Specify a link to some form of media |
| | | (e.g., PDF, SWF etc.) |
| pSeeIt | See | Specify a link to some form of media |
| | | (e.g., PDF, SWF etc.) |
| pDoIt | Do | Specify a link to one or more applications to launch; can |
| | | include specification of a workspace to display |

After a particular trial is defined and is sufficiently characterized with user activity tags (e.g., as per the aforementioned metadata), instances of that trial are ready for interactive use by a user. When a user launches the trial application or portion thereof (e.g., a rendering application as further described below), the user might be presented with a login screen or other device for the user to supply user credentials. These credentials can include user roles, and/or can map to a set of roles permitting (or possibly restricting) access to functionality exposed in the trial. For example, a user having a particular role, might be permitted to perform all functions of a given application except “saving”, and the act of saving might require an additional credential.

Once a user is authenticated, the trial application interrogates a process progression service to retrieve user activity rules. For example, user activity rules can comprise any one or more tasks (e.g., steps to take in the course of a trial). The user activity rules can comprise or be associated with completion events (e.g., milestones, completion of a business user activity, etc.). And a given set of user activity rules can comprise or be associated with the user's instance of the trial. Moreover, a given set of user activity rules can comprise or be associated with rendering rules, which rendering rules provide sufficient information so as to facilitate rendering of a graphical depiction of user activity rules (e.g., in the form of tasks, milestones, progressions from one task to another, and/or progression from one or more tasks to a milestone).

In certain embodiments, the metadata information is rendered in a rendering application in order to present a graphical depiction of user activity rules (e.g., in the form of tasks, milestones, progressions from one task to another, and/or progression from one or more tasks to a milestone marker). The depicted graph includes tasks (e.g., a node of the graph) and edges (e.g., a permitted progressions from task to task), and the connectivity of the nodes via edges serves to enforce the order of progression through the prescribed steps to complete the user activity.

In the embodiments described herein, a task has metadata associated with it, and a given task can take on an association with graphical components (e.g., boxes, lines, icons, etc.) which graphical components are displayed to the user, possibly using a rendering application (e.g., a browser) in conjunction with a process progression service. In some cases, graphical components representing tasks are organized into a table-like layout having several tasks on the same row (in separate columns). The graphical components are displayed for the user, and the graphical components are “live” in that the graphical components can take on an association with certain forms of user interaction (e.g., a click or a mouse gesture), and the rendering application can initiate certain actions when the user indicates a gesture. For example, a user click on a task might launch an application. Specific actions to be taken can be codified in the metadata. A selection of exemplary actions corresponding to a particular tag is given in Table 2.

TABLE 2
Tag to Action Map

| Tag | Task Label | Exemplary Actions |
|---|---|---|
| pReadIt | Read | Display media in a popup window |
| pSeeIt | See | Display media in a popup window |
| pDoIt | Do | Launch an application using |
| | | applications launch parameters |

The graphical components and icons can be rendered so as to aid the user in the progression through the process flow. For example, the graphical components representing activities can be disabled (e.g., grayed out) if the corresponding user activity (e.g., task or tasks) is not yet complete. In some embodiments, when presenting to a particular user, the graphical components representing activities can be disabled (e.g., grayed out) if the corresponding user activity is not assigned to that particular user. This mechanism helps guide a particular user through a predefined sequence of steps to complete a business user activity while observing the user's roles (and the security model underlying the user role).

In exemplary initial renderings of a process flow, graphical components (e.g., the aforementioned user activity boxes, icons, etc.) are enabled, and the corresponding links are activated. As earlier mentioned, a graphical component might be enabled only if the particular user activity is assigned to the particular user. Further, the act of enabling a graphical component corresponding to a task can happen automatically under control of an external application (e.g., an external application, or an external application in cooperation with a task processing service). For example, a graphical component corresponding to a task can be enabled when its predecessor tasks are completed. Indeed, in exemplary cases, the act of making such rendering changes (e.g., enabling a user activity or disabling a user activity) can be handled automatically by a rendering application in conjunction with an external application (or in conjunction with an external application in cooperation with a task processing service). Similarly, when tasks are deemed completed, a graphical component is rendered in the rendering application interface to indicate as much.

In embodiments, a system for implementing a flow control regime is responsive to an external application. In some cases, the trial is implemented atop a generic framework. In exemplary cases such a framework is delivered as software that reads metadata. As can now be understood, such a framework provides a flexible, scalable environment that supports any number of trials to be defined (e.g., via the metadata) and deployed without requiring changes to code or code updates to the trial deployment package. Customers can explore functionality at their own pace and on their own time. Given such a capability, users do not have to rely on a salesperson to demonstrate the capabilities of the software.

### Descriptions of Exemplary Embodiments

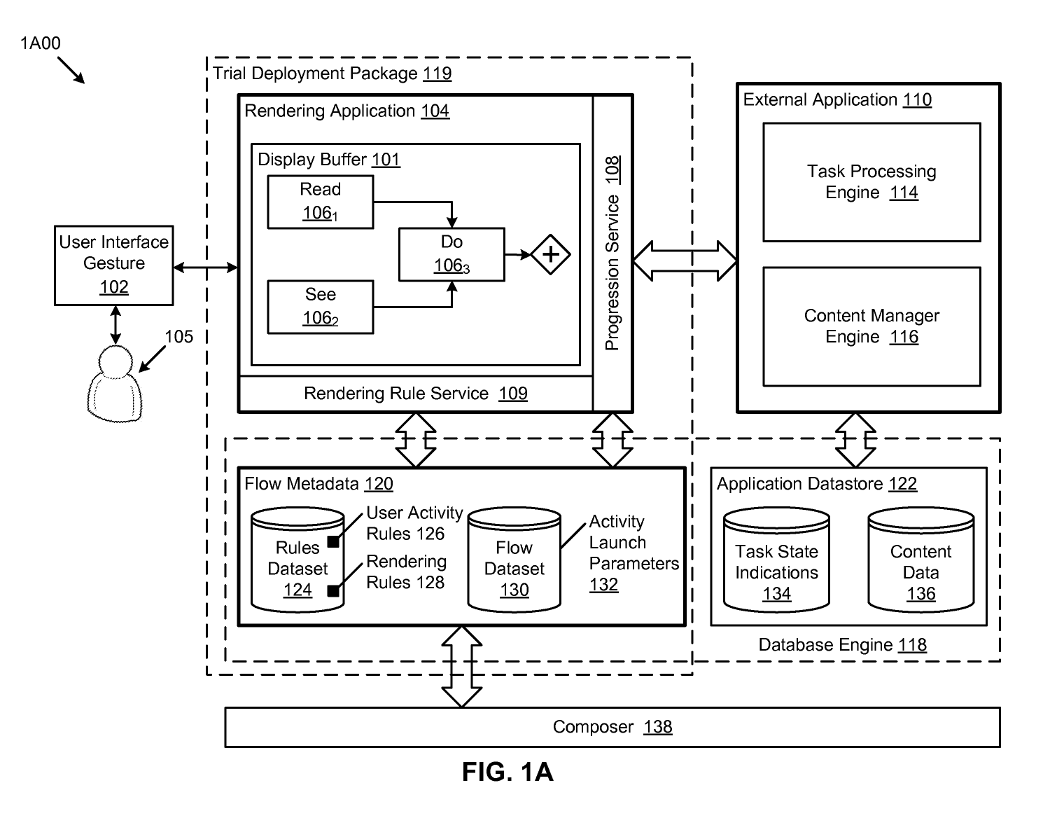

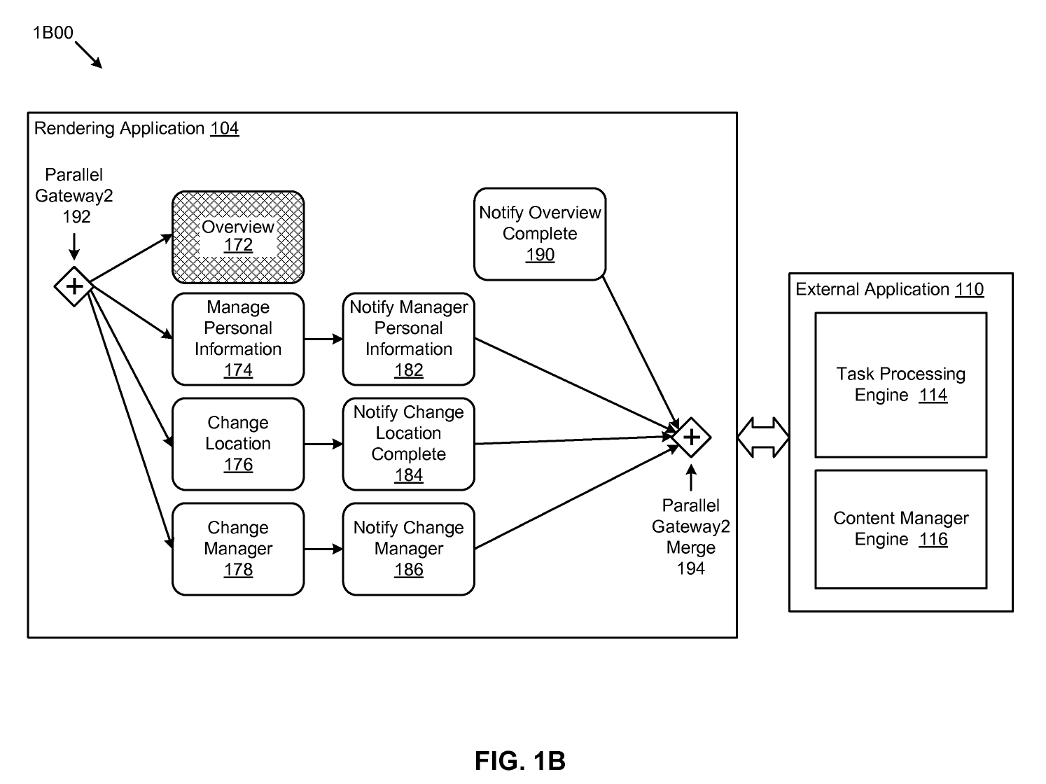

FIG. 1A is a block diagram of a system 1A00 for implementing browser-based process flow control responsive to an external application. As an option, the present system 1A00 may be implemented in the context of the architecture and functionality of the embodiments described herein. Also, the system 1A00 or any aspect therein may be implemented in any desired environment.

As shown, the system 1A00 comprises a rendering application 104 in bi-directional communication with an external application 110. The external application can be at least partially controlled by the rendering application (e.g., by a launch action in response to a user interface gesture), and the rendering application can be at least partially controlled by the external application (e.g., using a task processing engine 114). The bi-directional communication might go through a progression service 108, which service can process state-oriented aspects of events and metadata, thus leaving graphical component rendering operations to other services. Similarly, a rendering application might access rendering rules 128 via the metadata using a rendering rule service 109. In some embodiments a rendering rule service 109 interprets rendering rules in order to apply a “skin” or a look-and-feel to the graphic objects.

The rendering application serves to manage a display buffer 101 in order to display various components in a graphical user interface (e.g., using a display screen or other display surface), and the user 105 can interact with any graphical components in the interface. As earlier described, metadata (e.g., flow metadata 120) can prescribe what action to take when the user interacts with the various components of the interface. As shown, the rendering application depicts a READ type of prescribed user activity 106₁, a SEE type of prescribed user activity 106₂, and a DO type of prescribed user activity 106₃. The graphical components are “live” in that the graphical components can take on an association with certain forms of user interaction such as a click or a mouse gesture (e.g., from a user interface gesture 102), and the rendering application 104 can initiate certain actions when the user indicates a gesture.

For example, a user click on a graphical component corresponding to a READ type of prescribed user activity 106₁ might launch an application to display some text-based instructions in a pop-up window. Or a user click on a graphical component corresponding to a SEE type of prescribed user activity 106₂ might launch an application to display a video or photo or animation in a pop-up window. In this embodiment, the specific mechanics of the rendering application's response to a user interface gesture 102 is defined in the flow metadata 120. More particularly, the specific mechanics of the rendering application's response to a user interface gesture 102 is defined in a rules dataset 124, and a rules dataset 124 in turn comprises user activity rules 126 and rendering rules. Still more, the flow metadata can comprise a flow dataset 130. The flow dataset comprises metadata to permit/deny transitions based on various criteria, which criterion can be stored in the flow dataset 130.

In some cases, a user click on a graphical component corresponds to a DO type of prescribed user activity 106₃ might launch an application using activity launch parameters 132. As a specific example, the launching of an application based on a user click on a graphical component corresponding to a DO type of prescribed user activity 106₃ might launch an application function with one or more activity launch parameters 132 that provide arguments to the launched function. In another example, the activity launch parameters 132 might comprise merely an identification of an external application (or function therein) to be launched. In this manner of launching an external application or function within an external application, the user can at least partially control the trial. Yet, the progression from one task to another task, and/or the accomplishment of a milestone, is policed by the rendering application using the flow metadata in conjunction with the external application.

In an exemplary deployment, a trial deployment package can be delivered to a user (e.g., a sales prospect) and the trial deployment package 119 can comprise code for the rendering application 104 and flow metadata to describe specific aspects of the trial of the external application 110.

The external application can be any application. In some situations (e.g., a product demonstration situation) the external application is an enterprise software application, and the flow metadata is defined so as to aid the user to traverse through a particular set of product features. In other situations (e.g., a pre-sales product evaluation) the external application is an enterprise software application and the flow metadata is defined so as to aid the user to traverse through a particular set of evaluation tests or workloads.

The aforementioned metadata can be written manually, “by hand” (e.g., using a text editor), or the metadata can generated using a composer 138. The composer 138 supports flexible environments, and any portion of metadata can be manually generated. Alternatively, any portion of metadata can be machine-generated, and/or generated using computer-aided techniques (e.g., using a composer).

As earlier indicated, a user click on a graphical component corresponding to a READ type of prescribed user activity 106₁ might launch an application (e.g., using an activity launch parameter) to display some text-based instructions in a pop-up window. Or a user click on a graphical component corresponding to a SEE type of prescribed user activity 106₂ might launch an application to display a video in a pop-up window. In such cases, the content (e.g., text-based instructions, or the video to be seen) can be stored as content data 136, which in turn can be stored in a non-persistent storage such as an application data store 122, which in turn might be accessed and managed via a database engine 118. Any sort of content can be managed by a content manager engine 116, and a content manager engine can be embodied for access and control by the external application.

As the user interacts with the graphical components as displayed by the rendering application, and as the user progresses through the trial, the external application can store any instances of task state indications 134. Such a task state indication can store Boolean states, such a flag indicating the user has successfully progressed through some state, or a task state indication can store any series of states, possibly indicating any aspects pertaining to partial completion of an application function and/or partial completion of an application evaluation step.

As can now be seen, the system 1A00 implements a framework that can support any number or variation of trials (e.g., via the metadata) and the framework can deployed as a trial deployment package 119. Thus, sales prospects and customers can explore product functionality at their own pace and on their own time. Given such a capability, users do not have to rely on a salesperson to demonstrate the capabilities of the software.

FIG. 1B is a block diagram showing dynamic rendering in a system 1B00 for implementing browser-based process flow control responsive to an external application. As an option, the present system 1B00 may be implemented in the context of the architecture and functionality of the embodiments described herein. Also, the system 1B00 or any aspect therein may be implemented in any desired environment.

As shown, the rendering application 104 renders a graph in a display comprising a plurality of graphical components corresponding to the respective prescribed user activities. In this example, the prescribed user activity labeled as Overview 172 is greyed out or hatched-out (disabled). In this rendering, the greyed-out nature of the prescribed user activity Overview represents that that prescribed user activity has been completed and that the external application 110 has so indicated. In this example, the Overview 172 was assigned to a SEE type of prescribed user activity, and the user's gesture (e.g., a click) launches a video. The content manager engine 116 operated to serve the video to the external application, and the external application in turn served the video to the rendering application. Thus, the external application (e.g., the software product being evaluated) performed operations at the direction of the prospect (namely to serve the video to the rendering application) and returned an indication of state progression upon the user's successful completion of watching the video clip.

In addition to the aforementioned prescribed user activity labeled as Overview 172, the system 1B00 shows additional prescribed user activities in the window of the rendering application. Specifically, the prescribed user activities include Manage Personal Information 174, Change Location 176, and Change Manager 178, all of which proceed from the milestone Parallel Gateway2 192. As shown, any of prescribed user activities in that column (e.g., see 174, 176, and 178) are enabled and ready to accept a gesture from the user.

The next column to the right shows prescribed user activities that include Notify Manager Personal Information 182, Notify Change Location Complete 184, and Notify Change Manager 186. As shown those prescribed user activities (see 182, 184, 186) are not greyed-out or hatched-out, but are nevertheless inactive since they depend on a user activity that is not yet complete. In certain embodiments, currently unreachable user activities are greyed-out.

Still referring to the present system 1B00, the milestone Parallel Gateway2 Merge 194 becomes active (e.g., available to receive a user interface gesture corresponding to that activity) when all of its predecessor user activities have been deemed completed. Thus, even after the just mentioned user activities (see 182, 184, 186) have been deemed complete, the milestone Parallel Gateway2 Merge 194 cannot be achieved until the user activity Notify Overview Complete 190 has been deemed complete.

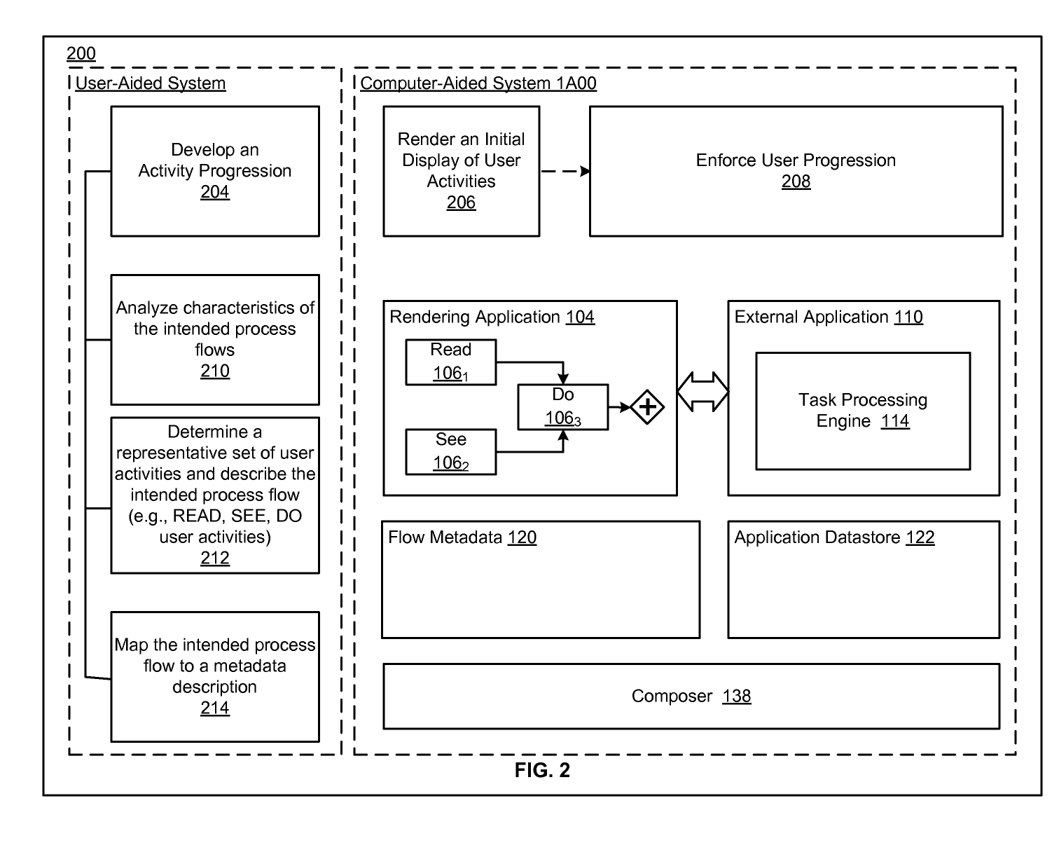

FIG. 2 is a function-to-module map 200 for implementing browser-based process flow control responsive to an external application. As an option, the present function-to module map 200 may be implemented in the context of the architecture and functionality of the embodiments described herein. Also, the function-to module map 200 or any aspect therein may be implemented in any desired environment.

As earlier indicated, some embodiments are constructed around a framework to provide a flexible, scalable environment that supports any number of trials defined (e.g., using metadata), and changes to metadata can be deployed without requiring changes to code or code updates to the rendering application.

The function-to module map 200 shows various stages of development and deployment for implementing browser-based process flow control responsive to an external application. In one case, an administrator can develop an activity progression 204, as a part of analyzing characteristics of the intended process flows 210. When activity progression is sufficiently well understood, the administrator can determine a representative set of prescribed user activities and can perform steps to describe a process flow 212. For example, one way to perform steps to describe a process flow 212 is to map the intended process flow to a metadata description (see box 214). A composer 138 might be used to aid in the process to map the intended process flow to a metadata description.

Now, for aiding a user through a trial or demo or evaluation, the computer-aided techniques of system 1A00 can be employed. Specifically, the intended process flow that had been mapped to a metadata description (see box 214) can be accessed by a rendering application 104 (see flow metadata 120) so as to render (at least) an initial display of user activities (see box 206), and the interaction between the rendering application and the external application commences. Such an interaction serves to enforce a user's progression through the trial (see box 208).

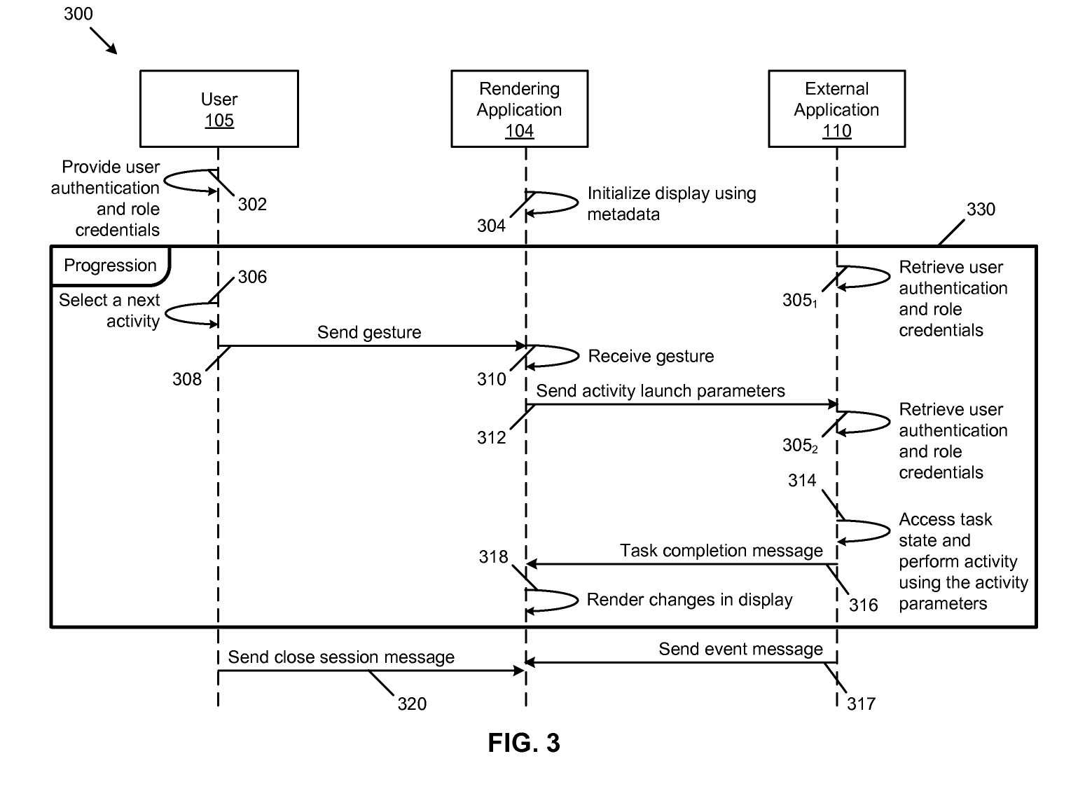

FIG. 3 is a sequence diagram representation of a protocol 300 used in systems for browser-based process flow control responsive to an external application. As an option, the present protocol 300 may be implemented in the context of the architecture and functionality of the embodiments described herein. Also, the protocol 300 or any aspect therein may be implemented in any desired environment.

As shown, the present protocol 300 commences when a user 105 launches a rendering application (e.g., begins a session within a trial), and provides user authentication credentials, including a direct or indirect indication of the user's role (see operation 302). The rendering application 104 uses metadata to determine the look and feel of an initial display (see operation 304). As earlier indicated, the user role is used by the external application 110 to determine if the user is permitted to perform a particular selected user activity (see operation 305₁, and operation 305₂). The protocol proceeds to enforce the progression. Strictly as an example, the protocol 300 might cycle within progression loop 330, beginning a cycle when the user 105 selects a next activity (see operation 306) and selects that next activity via a user interface gesture, which in turn is sent to the rendering application (see message 308). The user interface gesture corresponding to a selected next activity is received by the rendering application (see operation 310). In certain embodiments, the selected next activity is associated with a graphical component, and the graphical component is associated with one or more activity launch parameters, thus the rendering application can send activity launch parameter to the external application (see message 312).

The external application 110 does not necessarily perform any actions to perform the activity indicated by the activity launch parameters; instead, in exemplary embodiments, the external application 110 retrieves user authentication and role credentials (see operation 305₂) and checks that the authenticated user has sufficient role (e.g., authority) credentials to perform the selected activity. If so, the external application accesses the task state and performs corresponding tasks using the activity launch parameters (see operation 314). Having completed the tasks of operation 314, and having stored any task state changes in task state indications 134, the external application sends a task completion message 316 to the rendering application 104. After receipt and processing of the task completion message 316, the rendering application 104 renders changes in display window to form an updated display (see operation 318). Asynchronously, the external application 110 can send an event (see message 317). As shown, the cycle within progression loop 330 continues until the user determines to end the session, and does so via sending a close session message (see message 320).

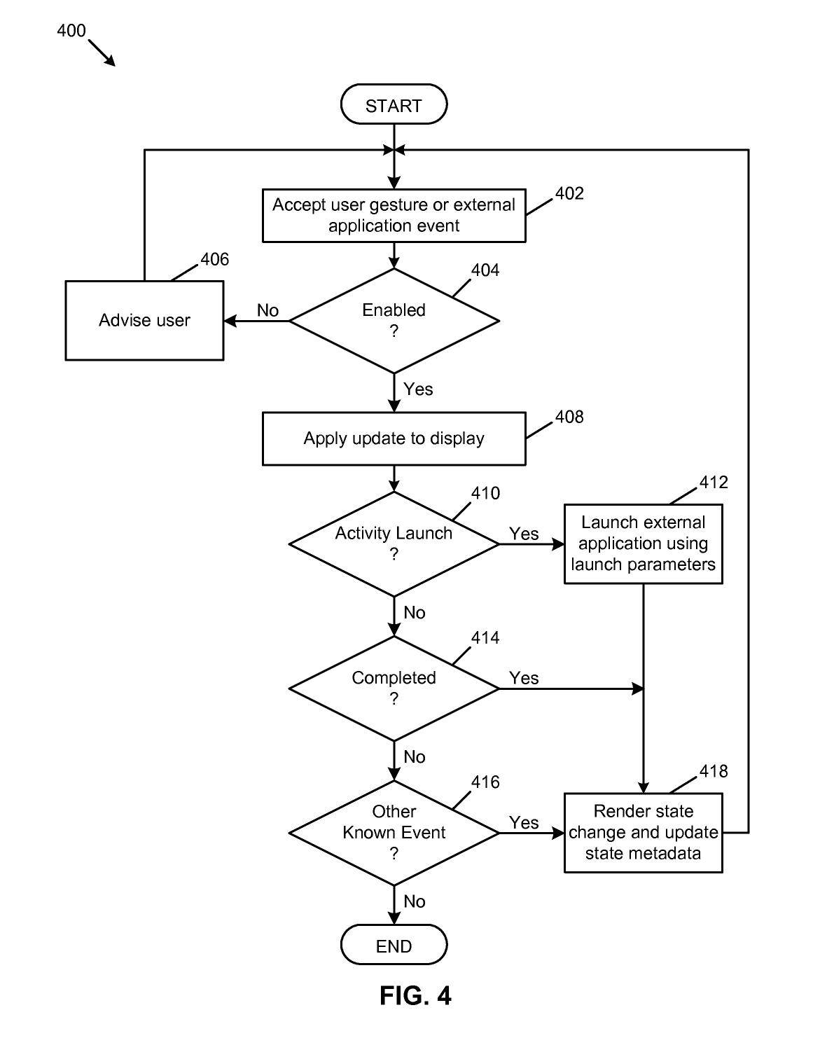

FIG. 4 is a flow chart representation of a technique 400 for updating a display in a system for browser-based process flow control responsive to an external application. As an option, the present technique 400 may be implemented in the context of the architecture and functionality of the embodiments described herein. Also, the technique 400 or any aspect therein may be implemented in any desired environment.

As shown, the technique 400 for updating a display commences at “START” and accepts a user interface gesture or an event from an external application (see operation 402). In an exemplary embodiment, a rendering application can pick up the user interface gesture or an event from an external application and determine if the next activity corresponding to the user interface gesture or an event from an external application is enabled (see decision 404), and if not then advises the user that the next activity is not enabled (see operation 406). The aforementioned advice can come in the form of a graphical indication (e.g., a screen flash, or an audible indication, or a message, etc.). In the case the next activity corresponding to the user interface is enabled, then the processing proceeds to apply an update to the display (see operation 408). In the case that the user interface gesture referred to any of the several aforementioned activity types that are intended to launch an application, then steps are taken to launch that application. The steps might include launching an external application using retrieved launch parameters (see operation 412). At any time, including multiple times in the same session, the rendering application can pick up an event from an external application and determine if the event refers to a task or other activity completion (see decision 414). If so, then the processing proceeds to render state changes (e.g., via a rendering application) and/or update any task state indications 134 (see operation 418). It is possible that a rendering application can pick up the user interface gesture and/or any other application can process an event from an external application, and it is possible that the gesture or event is not an activity launch (see decision 410) and that the gesture or event is not an activity completion (see decision 414). In such a case, the gesture or event is checked against other known events (see decision 416), and if so processing proceeds to render state changes (e.g., via a rendering application) and/or update any task state indications 134 (see operation 418).

### Additional Embodiments of the Disclosure

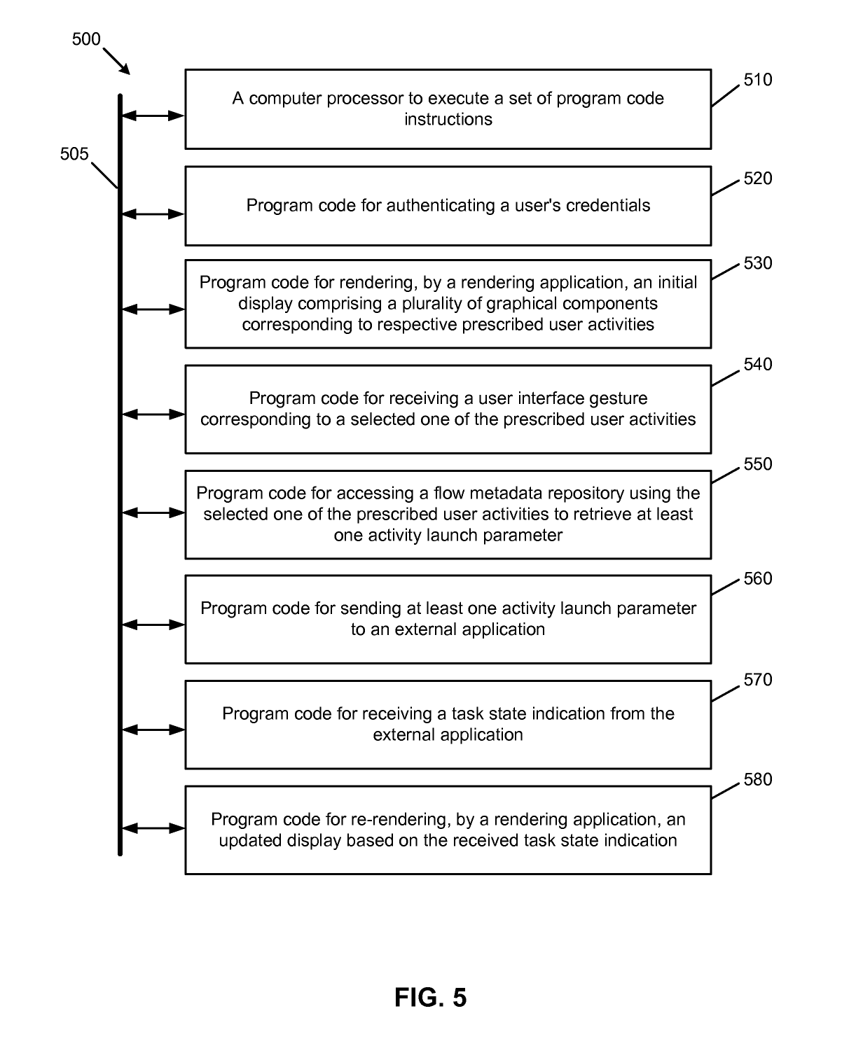

FIG. 5 is a block diagram of a system to perform certain functions of a computer system. As an option, the present system 500 may be implemented in the context of the architecture and functionality of the embodiments described herein. Of course, however, the system 500 or any operation therein may be carried out in any desired environment. As shown, system 500 comprises at least one processor and at least one memory, the memory serving to store program instructions corresponding to the operations of the system. As shown, an operation can be implemented in whole or in part using program instructions accessible by a module. The modules are connected to a communication path 505, and any operation can communicate with other operations over communication path 505. The modules of the system can, individually or in combination, perform method operations within system 500. Any operations performed within system 500 may be performed in any order unless as may be specified in the claims. The embodiment of FIG. 5 implements a portion of a computer system, shown as system 500, comprising a computer processor to execute a set of program code instructions (see module 510) and modules for accessing memory to hold program code instructions to perform: authenticating a user's credentials (see module 520); rendering, by a rendering application, an initial display comprising a plurality of graphical components corresponding to respective prescribed user activities (see module 530); receiving a user interface gesture corresponding to a selected one of the prescribed user activities (see module 540); accessing a flow metadata repository using the selected one of the prescribed user activities to retrieve at least one activity launch parameter (see module 550); sending at least one activity launch parameter to an external application (see module 560); receiving a task state indication from the external application (see module 570); and re-rendering, by a rendering application, an updated display based on the received task state indication (see module 580).

### System Architecture Overview

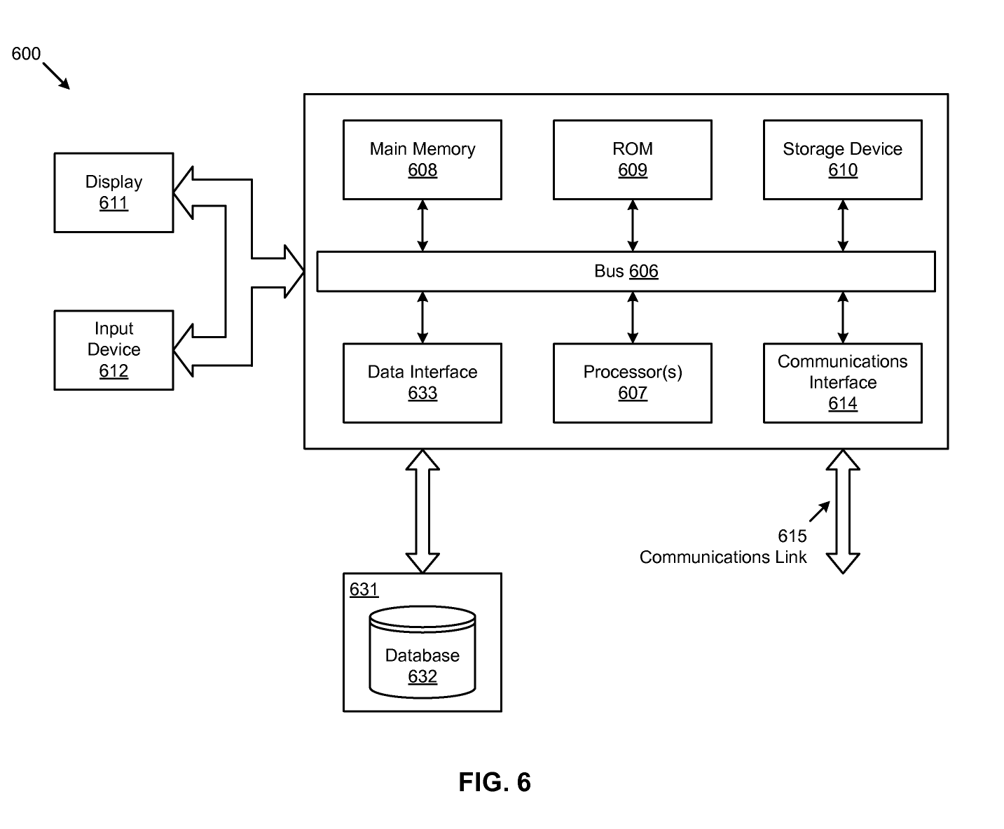

FIG. 6 depicts a block diagram of an instance of a computer system 600 suitable for implementing an embodiment of the present disclosure. Computer system 600 includes a bus 606 or other communication mechanism for communicating information, which interconnects subsystems and devices, such as a processor 607, a system memory 608 (e.g., RAM), a static storage device (e.g., ROM 609), a disk drive 610 (e.g., magnetic or optical), a data interface 633, a communication interface 614 (e.g., modem or Ethernet card), a display 611 (e.g., CRT or LCD), input devices 612 (e.g., keyboard, cursor control), and an external data repository 631.

According to one embodiment of the disclosure, computer system 600 performs specific operations by processor 607 executing one or more sequences of one or more instructions contained in system memory 608. Such instructions may be read into system memory 608 from another computer readable/usable medium, such as a static storage device or a disk drive 610. In alternative embodiments, hard-wired circuitry may be used in place of or in combination with software instructions to implement the disclosure. Thus, embodiments of the disclosure are not limited to any specific combination of hardware circuitry and/or software. In one embodiment, the term “logic” shall mean any combination of software or hardware that is used to implement all or part of the disclosure.

The term “computer readable medium” or “computer usable medium” as used herein refers to any medium that participates in providing instructions to processor 607 for execution. Such a medium may take many forms, including but not limited to, non-volatile media and volatile media. Non-volatile media includes, for example, optical or magnetic disks, such as disk drive 610. Volatile media includes dynamic memory, such as system memory 608.

Common forms of computer readable media includes, for example, floppy disk, flexible disk, hard disk, magnetic tape, or any other magnetic medium; CD-ROM or any other optical medium; punch cards, paper tape, or any other physical medium with patterns of holes; RAM, PROM, EPROM, FLASH-EPROM, or any other memory chip or cartridge, or any other non-transitory medium from which a computer can read data.

In an embodiment of the disclosure, execution of the sequences of instructions to practice the disclosure is performed by a single instance of the computer system 600. According to certain embodiments of the disclosure, two or more computer systems 600 coupled by a communication link 615 (e.g., LAN, PTSN, or wireless network) may perform the sequence of instructions required to practice the disclosure in coordination with one another.

Computer system 600 may transmit and receive messages, data, and instructions, including programs (e.g., application code), through communication link 615 and communication interface 614. Received program code may be executed by processor 607 as it is received, and/or stored in disk drive 610 or other non-volatile storage for later execution. Computer system 600 may communicate through a data interface 633 to a database 632 on an external data repository 631. A module as used herein can be implemented using any mix of any portions of the system memory 608, and any extent of hard-wired circuitry including hard-wired circuitry embodied as a processor 607.

In the foregoing specification, the disclosure has been described with reference to specific embodiments thereof. It will, however, be evident that various modifications and changes may be made thereto without departing from the broader spirit and scope of the disclosure. For example, the above-described process flows are described with reference to a particular ordering of process actions. However, the ordering of many of the described process actions may be changed without affecting the scope or operation of the disclosure. The specification and drawings are, accordingly, to be regarded in an illustrative sense rather than restrictive sense.

What is claimed is:

1. A computer implemented method for browser-based process flow control responsive to an external application, the method comprising:
rendering, by a processor, an initial display comprising a plurality of graphical components corresponding to respective prescribed user activities;
receiving from a user interface device, a user interface gesture corresponding to a selected one of the prescribed user activities;
accessing a flow metadata repository using the selected one of the prescribed user activities to retrieve at least one activity launch parameter;
sending at least one activity launch parameter to an external application;
receiving a task state indication from the external application; and
re-rendering an updated display based on the received task state indication.

2. The method of claim 1, wherein at least some of the graphical components corresponding to respective prescribed user activities are disabled.

3. The method of claim 1, wherein the flow metadata repository comprises at least one of, an activity rule, or a rendering rule.

4. The method of claim 1, wherein at least one of the graphical components corresponds to at least one of, a READ type of prescribed user activity, a SEE type of prescribed user activity, or DO type of prescribed user activity.

5. The method of claim 4, wherein the SEE type of prescribed user activity launches a video.

6. The method of claim 4, wherein the DO type of prescribed user activity launches a function within the external application.

7. The method of claim 1, wherein sending the at least one activity launch parameter to an external application further comprises launching the external application.

8. The method of claim 1, further comprising authenticating a user's credentials to determine at least one role of the authenticated user.

9. A computer system for browser-based process flow control responsive to an external application, comprising:
a computer processor to execute a set of program code instructions; and
a memory to hold the program code instructions, in which the program code instructions comprises program code to perform,
rendering an initial display comprising a plurality of graphical components corresponding to respective prescribed user activities;
receiving a user interface gesture corresponding to a selected one of the prescribed user activities;
accessing a flow metadata repository using the selected one of the prescribed user activities to retrieve at least one activity launch parameter;
sending at least one activity launch parameter to an external application;
receiving a task state indication from the external application; and
re-rendering an updated display based on the received task state indication.

10. The computer system of claim 9, wherein at least some of the graphical components corresponding to respective prescribed user activities are disabled.

11. The computer system of claim 9, wherein the flow metadata repository comprises at least one of, an activity rule, or a rendering rule.

12. The computer system of claim 9, wherein at least one of the graphical components corresponds to at least one of, a READ type of prescribed user activity, a SEE type of prescribed user activity, or DO type of prescribed user activity.

13. The computer system of claim 12, wherein the SEE type of prescribed user activity launches a video.

14. The computer system of claim 12, wherein the DO type of prescribed user activity launches a function within the external application.

15. A computer program product embodied in a non-transitory computer readable medium, the computer readable medium having stored thereon a sequence of instructions which, when executed by a processor causes the processor to execute a process to implement browser-based process flow control responsive to an external application, the process comprising:
rendering an initial display comprising a plurality of graphical components corresponding to respective prescribed user activities;
receiving a user interface gesture corresponding to a selected one of the prescribed user activities;
accessing a flow metadata repository using the selected one of the prescribed user activities to retrieve at least one activity launch parameter;
sending at least one activity launch parameter to an external application;
receiving a task state indication from the external application; and
re-rendering an updated display based on the received task state indication.

16. The computer program product of claim 15, wherein at least some of the graphical components corresponding to respective prescribed user activities are disabled.

17. The computer program product of claim 15, wherein the flow metadata repository comprises at least one of, an activity rule, or a rendering rule.

18. The computer program product of claim 15, wherein at least one of the graphical components corresponds to at least one of, a READ type of prescribed user activity, a SEE type of prescribed user activity, or DO type of prescribed user activity.

19. The computer program product of claim 15, wherein sending the at least one activity launch parameter to an external application further comprises launching the external application.

20. The computer program product of claim 15, further comprising authenticating a user's credentials to determine at least one role of the authenticated user.
